(19) United States
(12) Patent Application Publication
(10) Pub. No.: US 2026/0307678 A1
(43) Pub. Date: Oct. 8, 2026

(54) Method and Assistance System for Controlling a Motor Vehicle Based on Object and Area Recognition and Correspondingly Configured Motor Vehicle

(71) Applicant: Bayerische Motoren Werke Aktiengesellschaft, Muenchen (DE)

(72) Inventor: Christoph MAYSER, Unterhaching (DE)

(21) Appl. No.: 19/478,899

(22) PCT Filed: Apr. 9, 2024
(86) PCT No.: PCT/DE2024/100285

§ 371 Date: Oct. 27, 2025

(30) Foreign Application Priority Data
May 9, 2023 (DE) 10 2023 112 024.7

(51) Int. Cl. B60W 60/00; B60W 30/09; G06T 7/11; G06V 20/58

(52) U.S. Cl. CPC B60W 60/0015; B60W 30/09; G06T 7/11; G06V 20/58; B60W 2420/403; B60W 2420/408; B60W 2554/40

(57) ABSTRACT

The invention relates to a method and to an assistance system for controlling a motor vehicle, and to a corresponding motor vehicle. In the method, surroundings data from a first surroundings sensor are taken as a basis for carrying out object recognition in order to recognize other road users in a respective relevant region that are relevant to an upcoming driving decision of the motor vehicle. Surroundings data from a second surroundings sensor operating in accordance with another operating principle are taken as a basis for carrying out area recognition for the relevant region in order to recognize the relevant region as a clear driveable area. The driving decision is then made depending on whether the object recognition and the area recognition deliver mutually consistent results.

### BACKGROUND AND SUMMARY

The present invention is in the field of vehicle technology and relates to a method and to an assistance system for controlling a motor vehicle in at least semiautomated operation. The invention furthermore relates to a correspondingly configured motor vehicle.

Efforts are currently being made to automate the driving operation of motor vehicles. For this purpose, the respective surroundings of the motor vehicle are typically sensorially detected in order to be able to guide the motor vehicle correctly along the roadway in an automated manner and avoid collisions in this case. This has to be more accurate and more reliable the more responsibility is transferred to automated vehicle control or the higher the degree of automation is. Up to now, such surroundings recognition has not yet been absolutely accurate and reliable in all situations, however, so that there is a further demand for improvements here.

As one approach, DE 11 2019 000 048 T5 relates to determining a drivable free space for autonomous vehicles. A method is provided therein, in which detected sensor data are applied to a neural network. A group of boundary points which are represented by the sensor data and which correspond to a boundary that divides the drivable free space from a non-drivable space in the surroundings of a vehicle is calculated thereby. Locations in the surroundings are then determined, which correspond to the group of boundary points. Furthermore, class designations are calculated for boundary points of the group of boundary points. Finally, an operation is carried out to control the vehicle through the surroundings depending on the locations and the class designations.

As a further approach, DE 10 2021 129 825 A1 relates to object recognition and collision avoidance using a neural network. A circuit is provided therein to use a neural network in order to identify an object with which a vehicle can collide based on a difference between the size of an image of the object, which is recognized at a first time, and a size of an image of the object, which is recognized at a following time.

As a further approach, DE 10 2021 119 871 A1 describes a method for operating an automated driving function in a motor vehicle. Individual objects in the surroundings of the motor vehicle are recognized therein from sensor data by means of an object classifier. A pairwise object relationship is then recognized for some of the individual objects by means of a relationship classifier. By means of an aggregation module, corresponding relationship data are aggregated over multiple successive individual image representations of the surroundings to form aggregation data which describe aggregated object relationships. These aggregation data are then provided for object tracking and/or for trajectory planning.

An object of the present invention is to enable particularly safe and reliable at least semiautomated driving operation of a motor vehicle.

This object is achieved by the subjects of the main claim and the other independent claims or the independent patent claims. Further possible designs of the invention are disclosed in the dependent claims, the description and the figures. Features, advantages and possible designs which are outlined in the scope of the description for one of the subjects of the independent claims are to be considered at least analogously as features, advantages and possible designs of the respective subject matter of the other independent claims and any possible combination of the subjects of the independent claims, possibly in conjunction with one or more of the dependent claims.

A method according to the invention can be applied for controlling a motor vehicle in at least semiautomated operation. This can thus be driving operation of the motor vehicle in at least autonomy level 2, for example according to SAE J3016. The method according to the invention comprises multiple method steps which can be carried out in an automated manner, for example by an assistance system configured to carry out the method or for use in the method. In one method step of a method according to the invention, surroundings data, which characterize, thus, for example, represent or depict, the respective surroundings of the motor vehicle, are recorded by means of at least one first surroundings sensor and at least one second surroundings sensor. The first surroundings sensor and the second surroundings sensor operate independently of one another here and according to different functional principles. The surroundings data thus accordingly originate from at least two different data sources or comprise at least two different types of surroundings data. The recorded surroundings data can be captured or received by the assistance system in each case.

In a further method step of a method according to the invention, object recognition is carried out for a region of the surroundings that is relevant for an upcoming automated driving decision for a planned driving maneuver of the motor vehicle, thus, for instance, for a corresponding driving decision of a system for the at least semiautomated control of the motor vehicle. This object recognition is carried out here based on surroundings data from the first surroundings sensor, thus accordingly by means of a first methodology, for recognizing other road users, relevant for the driving decision, in the relevant area. The driving decision can relate to or comprise, for example, whether or when or how the planned driving maneuver of the motor vehicle is to be carried out. It can thus be decided here, for example, whether the motor vehicle is to be guided further, thus is to be moved further, directly along its route or whether the motor vehicle is initially to be stopped, for example. The control of the motor vehicle according to the planned driving maneuver can thus mean or comprise depending on the situation, for example, that the motor vehicle automatically directly continues moving in the planned manner or is initially temporarily slowed or stopped, for example to give the priority to another recognized road user, thus initially to let them pass. A corresponding planned automated stop can then thus be part of the driving maneuver or part of the intended execution of the driving maneuver. Another road user, i.e. one different from the motor vehicle, can thus be relevant for the driving decision, for example, if the road user has priority with respect to the motor vehicle or will be obstructed when the motor vehicle executes the driving maneuver or would or could collide therewith.

Furthermore, area recognition is carried out here for the region of the surroundings that is relevant for the upcoming automated driving decision for the planned driving maneuver. This area recognition is carried out based on surroundings data from the second surroundings sensor, thus accordingly in particular by means of a second methodology different from the first methodology, for recognizing a free drivable area in the relevant region or for recognizing the relevant region as a free drivable area.

If another road user is thus located in the relevant region, said other road user can possibly be recognized based on the surroundings data of the first surroundings sensor, thus by means of the first methodology. In contrast, if no other road user is located in the relevant region, a free drivable area can be recognized there based on the surroundings data of the second surroundings sensor, thus by means of the second methodology. In practice, however, erroneous recognitions can occur. For example, another road user who is actually present may not be recognized, thus may be overlooked, erroneously. Likewise, for example, a free drivable area can erroneously be recognized although another road user is actually located there or no free drivable area can be recognized although it is present. In order to achieve the highest possible level of safety and robustness in the at least semiautomated control of the motor vehicle, the motor vehicle is not to be guided or moved based on such erroneous recognition in a potentially safety-critical situation. However, recognizing erroneous recognitions based on sensor data of a single surroundings sensor on the basis of these surroundings data themselves can be problematic.

According to the invention, in a further method step of a method according to the invention, the driving decision is therefore made depending on whether the object recognition and the area recognition supply results consistent with one another or to one another. If this is the case, thus with consistent results of the object recognition and the area recognition, the motor vehicle is controlled in an at least semiautomated manner in accordance with the consistent results according to the planned driving maneuver. Otherwise, thus with inconsistent results, for example contradictory to one another, of the object recognition and the area recognition, in contrast, a specified or predefined safety measure or safety reaction is automatically caused or carried out to avoid a collision with another road user possibly present in the relevant region or to avoid another safety-critical situation. This safety measure or safety reaction can mean or comprise, for example, that the motor vehicle is automatically stopped or the control of the motor vehicle is transferred to the driver of the motor vehicle or a confirmation is requested from the driver to carry out the planned driving maneuver, in particular to continue to move the motor vehicle, and/or the like. The control of the motor vehicle according to the planned driving maneuver with results of the object recognition and the area recognition that are consistent with one another, in contrast, can mean in particular that the motor vehicle is controlled in an automated manner and without querying to the driver. In this case, the motor vehicle can thus be set in motion again, for example, after a stop automatically and without prior confirmation by the driver in order to carry out or complete the planned driving maneuver. After stopping the motor vehicle that was carried out as a safety reaction, in contrast, the motor vehicle would not be set in automated motion again or would not be without prior confirmation by the driver.

In the present case, a consistency check, which is carried out in each case for a defined spatial region, based on different sensors or on the basis of different sensor or surroundings data originating from different sensors is thus proposed. The motor vehicle can therefore only be controlled in an automated manner, in particular moved further, if the relevant region is correctly recognized or if both the object recognition and the area recognition are simultaneously erroneous such that they nonetheless supply results consistent with one another. The latter is extremely improbable due to the different functional principles of the two surroundings sensors. Thus, an additional safeguard for the driving decision can thus be implemented by the present invention and therefore the level of safety in the at least semiautomated control of the motor vehicle and therefore also in the traffic situation can be enhanced overall.

A region relevant in each case for the driving decision or its position or location can in principle be known, for example, in each case on the basis of digital map data and the current position of the motor vehicle. For example, intersections, junctions, lanes or lane courses and/or the like can be entered as such in the map data and possibly be or have been classified as a relevant region in each case. In the at least semiautomated operation of the motor vehicle, for example in an automatically generated surroundings model or a detection list or the like, for example not only sensorially recognized objects, such as other road users or obstacles or the like, but also free drivable areas or gaps in traffic explicitly recognized as such, thus suitable and intended for driving, can be entered. It can then be checked in each case, for example, whether for the same spatial region or at the same point or position, both another road user and a free drivable area was recognized or whether only another road user or only a free drivable area was recognized there or whether neither another road user nor a free drivable area was recognized there. Based thereon, it can then be checked whether there is consistent surroundings recognition for these regions or inconsistencies or conflicts. This can be carried out for all regions or points or positions which are classified as relevant or potentially relevant for the respectively upcoming driving decision, thus a respectively upcoming driving maneuver. Which regions or points are relevant in each case can depend in the respective surroundings for example on road or lane courses, priority rules to be applied, expected or measured speeds of other road users, the speed of the motor vehicle, the planned route of the motor vehicle and/or the like.

The present invention also relates to an assistance system for a motor vehicle for the at least semiautomated control of the or a motor vehicle. The assistance system according to the invention has an input interface for capturing surroundings data of at least two different surroundings sensors. Furthermore, the assistance system comprises a data processing device for processing the surroundings data and for generating a control signal for controlling the motor vehicle equipped in each case with the assistance system or a device of this motor vehicle depending on the surroundings data or a respective result of the processing of the surroundings data. Furthermore, the assistance system has an output interface for outputting the respective control signal. The input interface and the output interface can be separate interfaces or can be combined or integrated in a common interface. The input interface and the output interface can each be implemented entirely or partially in hardware and/or in software.

The assistance system according to the invention is configured for the method according to the invention, thus for use in the method according to the invention. For this purpose, the data processing device can comprise a process device, thus, for example, a microchip or microprocessor or microcontroller or the like, and a computer-readable data memory coupled thereto. A corresponding operating or computer program, which codes or implements the method steps, measures or sequences or corresponding control instructions intended for execution in the assistance system or by means of the assistance system and described in conjunction with the method according to the invention, can be stored in this data memory. This operating or computer program can then be executable by means of the process device in order to carry out the corresponding method or cause it to be carried out. The assistance system according to the invention can thus in particular be or correspond to the assistance system mentioned in conjunction with the method according to the invention. The assistance system according to the invention can be designed, for example, as a vehicle controller or as a module of a vehicle controller or the like.

In one possible design of the present invention, the assistance system is configured to determine a region, into which the motor vehicle is to drive, for example according to automated trajectory or driving maneuver planning or a current navigation route or the like or in which another road user having priority over the motor vehicle-if present would be located or would have to be located, as the region of the surroundings that is relevant for the respective driving decision.

A corresponding region into which the motor vehicle is to drive can be, for example, a central region of an intersection to be driven through or to be traversed or a part of a road currently traveled by the motor vehicle, which leads past a junction, or a section of a lane adjoining a lane currently traveled by the motor vehicle, or the like. A region in which another road user having priority over the motor vehicle would be or have to be located can be, for example, a region of a junction that adjoins the road currently traveled by the motor vehicle or a part of a road intersecting the road currently traveled by the motor vehicle and superior thereto in the priority hierarchy, and/or the like. The size or length or extension of the relevant region can be dependent, for example, in each case on speeds of other road users that are expected or provided therein, wherein at higher speeds the relevant region can accordingly be larger.

By way of the design of the present invention that is proposed here, relevant regions which are particularly critical for a plurality of driving maneuvers and situations which are potentially hazardous in practice can be particularly easily and reliably defined and recognized and taken into consideration for the vehicle control.

In a further possible design of the present invention, the assistance system is configured to classify the results of the object recognition and of the area recognition as consistent with one another or to one another, to make the driving decision for the automatic control of the motor vehicle according to the planned driving maneuver and to generate and to output the corresponding control signal when and if no other road user has been recognized during the object recognition in the relevant region and the relevant region was recognized as a free drivable area during the area recognition or if another road user was recognized during the object recognition in the relevant region and the relevant region was not recognized as a free drivable area during the area recognition. Therefore, the probability can be reduced that the motor vehicle will be moved further in an automated manner because an actually relevant other road user was incorrectly overlooked by or during the object recognition or classified as not relevant. This can be achieved here in particular by the required positive recognition of the free drivable area. This is the case since such a free drivable area is typically not recognized or is not recognized with sufficient reliability or confidence, thus lying approximately above a specified threshold value if another road user is located there, even if they are possibly not recognized as such. If the other road user was recognized and therefore the relevant region was consistently not recognized as a free area, a correspondingly improved or particularly reliable data basis is thus present for the decision that the motor vehicle has to be stopped in an automated manner. In this case, this automated stop can thus be carried out based on the knowledge, which is correspondingly improved or confirmed by the consistency, about the presence of the other road user and not based on an excessively high uncertainty in the scope of the safety reaction. Therefore, the motor vehicle can then continue to be controlled in an automated manner, for example without involving its driver.

In a further possible design of the present invention, the assistance system is configured to classify the results of the object recognition and of the area recognition as inconsistent with one another or to one another to make the driving decision to execute the safety measure and to generate and to output the corresponding control signal when or if another road user was recognized during the object recognition in the relevant region and the relevant region was recognized as a free drivable area during the area recognition. Since a relevant other road user and a free drivable area cannot be located simultaneously at a specific point, a corresponding recognition conflict or erroneous recognition or misinterpretations is/are recognized particularly reliably by the criterion proposed here. This can also be the case in particular if both the object recognition and the area recognition each individually have or signal a sufficient recognition probability or recognition confidence. In this case the safety measure is caused or executed, a particularly high level of safety can be achieved. For example, it then does not have to be decided in a potentially error-prone or high-risk manner whether the object recognition or the area recognition is to be classified as trustworthy and used as the basis for the driving decision.

In a further possible design of the present invention, the assistance system is configured to classify the results of the object recognition and of the area recognition as inconsistent with one another or to one another, to make the driving decision to execute the safety measure and to generate and to output the corresponding control signal if no other road user was recognized during the object recognition in the relevant region and the relevant region was not recognized as a free drivable area during the area recognition. A region, which in principle is drivable in which another road user relevant for the respective driving decision could thus be located, can always be determined or observed as the relevant region. Accordingly, error recognition then has to thus exist either in the object recognition or in the area recognition and therefore an inconsistency has to be present if neither another road user nor a free drivable area is recognized in the relevant region. Accordingly, such an inconsistency can thus also be recognized if the results of the object recognition and of the area recognition do not directly contradict or do not appear to directly contradict immediately, thus, for example, not without further a priori assumption with respect to the relevant region. By the design of the present invention that is proposed here, such apparently conflict-free or contradiction-free situations can also be recognized and handled in a particularly safe manner.

In a further possible design of the present invention, the assistance system is configured to carry out the object recognition based on surroundings data from an active surroundings scan, in particular by means of radar or lidar, of the respective surroundings or of the respective relevant region. The surroundings data originating from the first surroundings sensor can thus in particular be or comprise radar echoes or lidar reflection points. Accordingly, for example, a radar sensor or a lidar sensor can be used as the first surroundings sensor. Such an active surroundings scan, thus based on the emission of signals and the detection of corresponding echoes or reflections, can enable particularly reliable and accurate object recognition, for example at least essentially independent of an ambient brightness. Correspondingly reliable automated control or guidance of the motor vehicle can therefore be enabled and excessively frequent prompting or execution of the specified safety measure can be avoided. This can be seen, for example, in comparison to object recognition based, in particular exclusively, on camera images, or the like.

In a further possible design of the present invention, the assistance system is configured to carry out the area recognition based on a semantic segmentation of a camera image of the respective surroundings or of the respective relevant region that is captured as part of the surroundings data. A free drivable area typically forms a contiguous uniform region which has a significant size, thus, at a distance relevant for an upcoming driving maneuver of the vehicle, typically comprises a plurality of pixels of the corresponding camera image. Such structures can be recognized particularly accurately, reliably and robustly based on the, in particular pixelwise, semantic segmentation. In particular, such drivable areas can therefore also be recognized reliably, accurately and robustly as such if, for example, no structural features, which would result in a reliable reflection of emitted signals of an active surroundings scan, are present there. Therefore, overall, upon use of the method according to the invention, particularly reliable automated control of the motor vehicle can finally be enabled, wherein in particular excessive prompting or performance of the specified safety measure can be avoided.

In a further possible design of the present invention, the assistance system is configured to generate and to output, in the case of results of the object recognition and of the area recognition that are inconsistent with one another or to one another, the control signal such that automatic stopping of the motor vehicle and/or a request or query for a confirmation for the control, in particular for the further movement, of the motor vehicle according to the planned driving maneuver from the driver of the motor vehicle is thus caused as the specified safety measure. The former can contribute to improved safety independently of the attentiveness state of the driver, since stationary traffic is typically associated with a lower safety risk than moving traffic, while—at least if the driver gives their confirmation for the control or further movement of the motor vehicle—a high level of safety and a high level of driving comfort and particularly high efficiency in the traffic situation or in the flow of traffic can be achieved at the same time by the latter, since the motor vehicle then possibly does not have to stop—possibly unnecessarily. Slowing of the motor vehicle can likewise be effected here by the control signal, however. The level of safety can thus likewise be increased and more time can be given to the driver to grasp the respective traffic situation and assess it correctly and accordingly respond or react correctly to the query. Furthermore, it can be provided that for the case that the driver does not react to the query or denies the confirmation, thus rejects the automated control or further movement of the motor vehicle according to the planned driving maneuver, the motor vehicle is stopped in an automated manner by the control signal or a further control signal then generated. This can likewise contribute to the level of safety and to the level of comfort, since the driver then, for example, does not have to manually stop the motor vehicle, which could possibly require more time than the automatic stopping of the motor vehicle.

The present invention also relates to a motor vehicle which is configured for at least semiautomated operation. The motor vehicle according to the invention comprises in this case a surroundings sensor system having at least one first surroundings sensor and one second surroundings sensor, which operate independently of one another and according to different functional principles. The motor vehicle according to the invention is equipped here with the assistance system according to the invention and/or configured to, in particular automatically, carry out the method according to the invention. The motor vehicle according to the invention can thus in particular be or correspond to the motor vehicle mentioned in conjunction with the method according to the invention and/or the motor vehicle mentioned in conjunction with the assistance system according to the invention. The motor vehicle according to the invention can thus comprise some or all of the corresponding properties and/or features. The motor vehicle according to the invention can comprise, for example, as part of the surroundings sensor system a radar device and/or lidar device and a camera. The motor vehicle according to the invention can likewise comprise, for example, a device or an interface for outputting a query to the driver and for capturing a corresponding response or reaction of the driver.

Further features of the invention can result from the claims, the figures and the description of the figures. The features and combinations of features mentioned above in the description and the features and combinations of features shown hereinafter in the description of the figures and/or solely in the figures are usable not only in the respectively specified combination, but also in other combinations or alone, without departing from the scope of the invention.

### BRIEF DESCRIPTION OF THE DRAWINGS

FIG. 1 shows a detailed schematic overview illustration of a traffic scene to illustrate a method for safely controlling a motor vehicle in at least semiautomated driving operation; and

FIG. 2 shows an exemplary schematic flow chart for a corresponding method for controlling the motor vehicle.

### DETAILED DESCRIPTION OF THE DRAWINGS

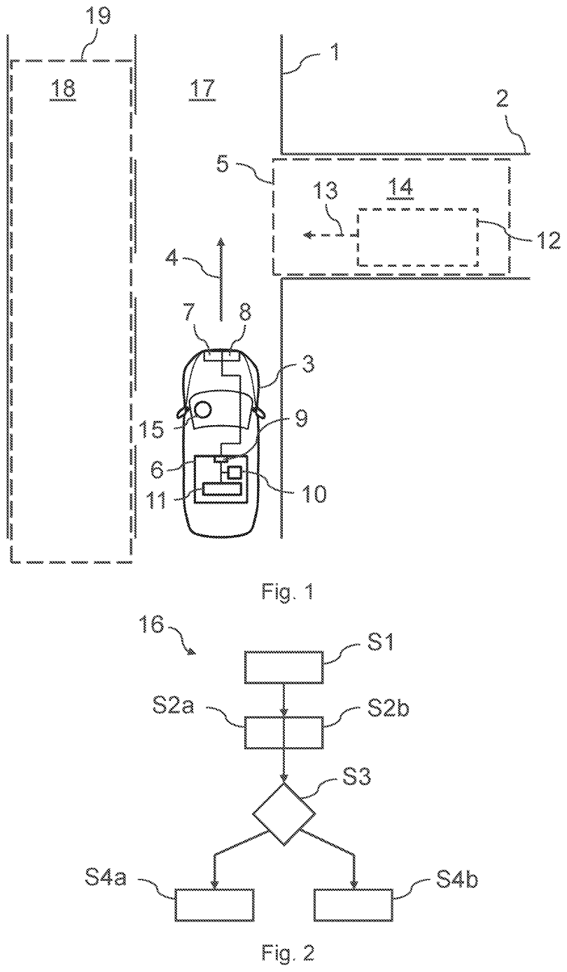

FIG. 1 shows a detailed schematic—and not to scale—overview illustration of a traffic scene having a road 1 and a junction 2 which opens into the road 1. In the situation shown here, a motor vehicle 3 drives on the road 1 in a direction of travel 4 indicated here by an arrow in the direction of the junction 2. It can be planned here as the next driving maneuver of the motor vehicle 3 to guide the motor vehicle 3 past the junction 2, following the road 1. As an example, it is to be a situation here in which the rule “right before left” applies. Therefore, another vehicle approaching the junction 2 and wishing to turn from there into the road 1 would thus have priority before the motor vehicle 3.

It has to be taken into consideration and reliably recognized whether another vehicle approaches the junction 2 for automated operation of the motor vehicle 3 or automated performance of the planned driving maneuver.

In previous approaches for this purpose, the focal point is on the question or determination of whether an object, such as another vehicle or another road user or the like, is located at a corresponding point, thus here, for example, in a schematically indicated relevance region 5, to which the motor vehicle 3 has to react, which is thus relevant for a driving maneuver or a corresponding driving decision of the motor vehicle 3. The relevance region 5 can be bounded here in its size or extension, in particular into the junction 2, as indicated here. This is the case since another vehicle that is closer in the junction 2, but is farther away, would not reach the road 1 before the motor vehicle 3 has driven past the junction 2. Such another vehicle would therefore not be relevant for the corresponding driving maneuver, thus here for the driving decision whether the motor vehicle 3 is to continue to drive or stop. One example of simpler automated vehicle control in relation thereto is represented by adaptive cruise control (ACC), in which an object is recognized or identified automatically as a preceding vehicle and then a reaction is always made to precisely this object by corresponding control.

In the present example shown of a priority situation, the motor vehicle 3 possibly has to stop if another object or another road user is recognized in the relevance region 5, which or who has priority. In contrast, if no other such road user is present there, the motor vehicle 3 can or should independently drive past the junction 2 in the direction of travel 4. In such a situation, erroneous recognition, thus overlooking another road user who is actually present in the relevance region 5 and has priority, could result in a potentially hazardous situation. Since therefore automated control of the motor vehicle 3 thus has to accept more responsibility to handle or manage such situations, there is also the requirement for an additional safeguard against corresponding recognition errors. The described situation that no other road user who has priority or is relevant is incorrectly recognized—although actually present—and the motor vehicle 3 is accordingly moved further in an automated manner has to be avoided for safety reasons. This is problematic if the motor vehicle 3 or its automatic control is only based on the criterion of whether or not a corresponding object was recognized, since a corresponding recognition error involves or is accompanied by a safety risk, since the recognition error can result in an erroneous safety-critical behavior of the motor vehicle 3.

To remedy this problem, the motor vehicle 3 is equipped in the present case with a correspondingly adapted or expanded assistance system 6. Furthermore, the motor vehicle 3 comprises a surroundings sensor system having a first surroundings sensor 7, which is designed here, for example, as radar or lidar, and a second surroundings sensor 8, which is designed here, for example, as a camera. The surroundings sensors 7, 8 operate independently of one another here based on different functional principles. The surroundings sensors 7, 8 can be coupled, for example, via an onboard network of the motor vehicle 3 to the assistance system 6 via an interface 9. In addition, the assistance system 6 can capture corresponding sensor or surroundings data of the first surroundings sensor 7 and the second surroundings sensor 8. The assistance system 6 comprises, schematically indicated here, a processor 10 and a computer-readable data memory 11 for processing these sensor or surroundings data and for generating a control signal as a function thereof.

To illustrate or explain the functionality of the assistance system 6, FIG. 2 shows an exemplary schematic flow chart 16 for a corresponding method for controlling the motor vehicle 3 by the assistance system 6 or by means of or using the assistance system 6. In a method step S1, the mentioned surroundings data are received therein and/or captured by the assistance system 6, for example via the interface 9. In the present case, surroundings data characterizing or depicting for example or at least the relevance region 5 are captured or earmarked by the assistance system 6 for further processing.

In a method step S2a, object recognition can then be carried out based on the surroundings data of the first surroundings sensor 7 for the relevance region 5. Depending on the situation, for example, a foreign vehicle 12 can be recognized or no such foreign vehicle 12 can be recognized here in the relevance region 5. The possibly recognized foreign vehicle 12 can be relevant for a further movement, thus the upcoming planned driving maneuver of the motor vehicle 3 and therefore a corresponding driving decision, since or if it approaches the junction 2 in a foreign vehicle direction of travel 13, indicated by an arrow here, of the road 1. If the foreign vehicle 12, in contrast, were to move in the opposite direction away from the road 1, for example, it could possibly be classified as not relevant for the driving decision or the further movement of the motor vehicle 3, although it can still be located in the relevance region 5.

For example in parallel thereto, in a method step S2b, a semantic segmentation can be carried out based on the surroundings data of the second surroundings sensor 8 or, if this was already carried out, for example, by the second surroundings sensor 8 itself, area recognition can be carried out to recognize the relevance region 5 as a drivable area 14. Depending on the situation, it can thus be recognized here that the relevance region 5 is occupied or filled, or not, completely or at least essentially or by at least a specified minimum proportion or up to at most a part which is smaller than a specified maximum size by the free drivable area 14. The possibly specified minimum proportion can be sufficiently large in each case, for example, that a possibly remaining proportion of the relevance region 5 would be significantly smaller than a possible other road user. The possibly specified maximum size can likewise comprise or represent, for example, an area region or a number of pixels which is/are significantly smaller than another road user possibly present in the relevance region 5, such as the foreign vehicle 12. Improved robustness of the method in relation to incorrect recognition or misclassification of individual pixels can thus be achieved. In principle, during the semantic segmentation, the class of that structure can be assigned to each pixel, thus each image point of a camera image captured as part of the surroundings data of the second surroundings sensor 8, of which this pixel forms or represents a part. Such possible classes can comprise, for example, “roadway surface” or “drivable area” or “motor vehicle” or the like.

In a method step S3, it is checked whether the results of the object recognition in method step S2a and the area recognition in method step S2b are consistent with one another or to one another. Based thereon, the driving decision for the planned driving maneuver of the motor vehicle 3 is then made and a corresponding control signal is generated. The above-discussed problem of conventional approaches which are based, for example, only on the object recognition by means of the first surroundings sensor 7, can thus be solved by applying or adding the semantic segmentation or the corresponding area recognition. It is thus not only used here as a criterion for the driving decision whether a relevant foreign vehicle 12 was recognized in the relevance region 5. Rather, it is additionally used or added as a criterion whether the relevance region 5 was recognized or not at least essentially completely as a free drivable area 14. The risk of incorrect behavior, based on a recognition error, of the motor vehicle 3 can therefore be reduced.

If the check in method step S3 has the result for example that, in a manner consistent with one another, no foreign vehicle 12 was recognized in the scope of the object recognition in method step S2a in the relevance region 5 and moreover the relevance region 5 was recognized as a free drivable area 14 in the scope of the area recognition in method step S2b, the driving decision to continue to move the motor vehicle 3 can then be made. Accordingly, a corresponding control signal can then be generated by the assistance system 6 and, in a method step S4a, the motor vehicle 3 can be moved further in an automated manner, thus in the present case driven or guided further in the direction of travel 4 along the road 1 past the junction 2. Likewise, the results of the object recognition and of the area recognition can be recognized or classified as consistent with one another if the foreign vehicle 12 was recognized in the relevant region 5 and the relevant region 5 was not recognized as a free area 14. In this case, the control signal can be generated such that the motor vehicle 3 likewise carries out the planned driving maneuver in an automated manner in method step S4a, but initially brakes or stops before the junction 2 in this case until the foreign vehicle 12 has turned into the road 1 and is only then guided past the junction 2.

In contrast, an inconsistency can be recognized in method step S3 if the relevant foreign vehicle 12 was recognized in the relevant region 5 in the scope of the object recognition and moreover the relevance region 5 was recognized as a free drivable area 14 in the scope of the area recognition. Likewise, in method step S3, an inconsistency can be recognized if no relevant foreign vehicle 12 was recognized in the relevance region 5 in the scope of the object recognition and the relevance region 5 was not recognized as a free drivable area 14 in the scope of the area recognition. A correspondingly different control signal can be generated in these cases by the assistance system 6. In a method step S4b, a specified safety reaction or safety measure can thus be prompted and executed. In this case, for example, a confirmation to continue to move the motor vehicle 3 can be obtained by its driver 15 by way of the assistance system 6 or the motor vehicle 3 can be automatically stopped before reaching the relevance region 5, thus before reaching the junction 2 here.

In situations such as the traffic scene shown here and having the junction 2 or else more complex intersection situations, the complexity and therefore also the requirements, for example, for correct object recognition or surroundings recognition in comparison to a pure following driving situation, in which the motor vehicle 3 solely drives straight ahead, for example, and automatically controls its distance to a preceding vehicle, substantially rise. In such more complex situations, there can thus be, for example, one or more other road users who can move in different or changing directions relative to the ego motor vehicle 3 and who possibly have to be taken into consideration. In such situations, the behavior, thus the automatic control of the motor vehicle 3, can be improved in comparison to conventional approaches if as described, in addition to the recognition of objects, such as the possibly present foreign vehicle 12, and the mapping thereof, thus the placing or locating thereof in a digitized map or in a digital surroundings model or the like, additionally, for example, regions or road sections known from a corresponding digital map of the respective surroundings are additionally evaluated or taken into consideration with respect to the criterion of recognition as a free drivable area 14. A corresponding geometry of the respective surroundings, thus here, for example, the positions and courses of the road 1 and the junction 2, can be known or taken from the respective specified digital map, so that based thereon, in each situation, the relevance region 5 to be taken into consideration for the respectively next driving decision or an upcoming driving decision can be determined. Likewise, such relevance regions 5 can already be, for example, contained or indicated in the digital map, thus corresponding specified map data. The assistance system 6 or the automated control of the motor vehicle 3 can therefore recognize and solve or handle corresponding situations reliabliy in a particularly automated manner.

A further exemplary situation in which the described method can be applied can comprise a lane change as an upcoming or planned driving maneuver of the motor vehicle 3. For example, in the present case the motor vehicle 3 drives on a first lane 17 of the road 1 and is to change from this to an adjacent second lane 18 of the road 1. For this purpose, a lane change relevance region 19 which is schematically indicated here can be taken into consideration. A sufficiently large gap or a sufficiently large free region thus has to be present there, for example, into which gap or region the motor vehicle 3 can drive, thus change, while maintaining the required safety distances both to a possibly preceding vehicle and also to a possibly following vehicle on the second lane 18. Moreover, it has to be taken into consideration whether another vehicle approaches at correspondingly high speed from the rear in the direction of travel 4 on the second lane 18, which would impermissibly be forced to break in the event of a lane change of the motor vehicle 3 into the second lane 18 and is therefore relevant for the lane change, thus the corresponding driving maneuver or the corresponding driving decision of the motor vehicle 3. For this purpose, the lane change relevance region 19 can extend further as indicated only to some extent to the rear of the motor vehicle 3, thus counter to the direction of travel 4.

It can be particularly challenging for automated surroundings recognition to recognize whether or that the lane change from the first lane 17 to the second lane 18 can be carried out safely if no gap bounded on both sides by other vehicles is recognized or is present, but rather only or at most another vehicle bounding the space or region available for the lane change maneuver to the front, thus in the direction of travel 4, is recognized or is present. In such a situation when the corresponding region is thus free to the rear or counter to the direction of travel 4, it can be problematic if a corresponding driving decision to execute the lane change maneuver would only be based on the object recognition not having recognized a relevant object there. This can also be bypassed or solved in the present case in that the area recognition is carried out for the lane change relevance region 19. The lane change maneuver can then only be executed if no relevant other road user was recognized in the lane change relevance region 19 and moreover the lane change relevance region 19 was recognized, in particular based on a corresponding semantic segmentation, as a drivable free area or roadway surface sufficiently large for the lane change maneuver.

The region relevant in a specific situation or for a specific driving maneuver or a specific driving decision can be determined not only on the basis of corresponding map data, but likewise, for example, on the basis of surroundings recognition. In the example of the lane change maneuver, the lane change relevance region 19 can thus be determined for instance on the basis of automatic recognition of lane markings and/or roadway boundaries and/or the like.

Overall, the examples described show how, for example, by the use of semantic segmentation for area recognition and object recognition independent thereof, for example in maintaining the priority situations, an elevated level of safety can be achieved in the traffic situation in the case of at least semiautomated vehicle guidance.

### LIST OF REFERENCE SIGNS

1 road
2 junction
3 motor vehicle
4 direction of travel
5 relevance region
6 assistance system
7 first surroundings sensor
8 second surroundings sensor
9 interface
10 processor
11 data memory
12 foreign vehicle
13 foreign vehicle direction of travel
14 drivable area
15 driver
16 flow chart
17 first lane
18 second lane
19 lane change relevance region

1.-10. (canceled)

11. A method for controlling a motor vehicle in at least semiautomated operation, the method comprising steps of:
automatically recording surroundings data with at least one first surroundings sensor and one second surroundings sensor, which operate independently of one another and according to different functional principles, the surroundings data characterizing the respective surroundings of the motor vehicle;
for a region of the surroundings that is relevant for an upcoming automated driving decision for a planned driving maneuver of the motor vehicle:
performing automatic object recognition, based on surroundings data from the first surroundings sensor, to recognize other road users relevant for the driving decision, and
performing automatic area recognition, based on surroundings data from the second surroundings sensor, to recognize the relevant region as a free drivable area; and
automatically making the driving decision dependent on whether the object recognition and the area recognition supply results are consistent with one another;
wherein when the object recognition and the area recognition supply results are consistent with one another, the motor vehicle is controlled in an automated manner according to the planned driving maneuver and otherwise a specified safety measure is executed to avoid a collision with another road user possibly present in the relevant region.

12. An assistance system for a motor vehicle configured to provide at least semiautomated control of the motor vehicle, the assistance system comprising:
an input interface configured to capture surroundings data of at least two different surroundings sensors;
one or more processors configured to process the surroundings data and to generate a control signal depending on the surroundings data; and
an output interface configured to output the control signal;
wherein the one or more processors are configured to execute the steps of the method according to claim 11.

13. The assistance system according to claim 12, wherein:
the one or more processors of the assistance system are configured to determine, as the region relevant for the respective driving decision, a region into which the motor vehicle is to drive or in which another road user having priority over the motor vehicle would be located.

14. The assistance system according to claim 12, wherein the one or more processors of the assistance system are configured to:
classify the results of the object recognition and of the area recognition as consistent with one another;
make the driving decision to control the motor vehicle according to the planned driving maneuver; and
output the corresponding control signal when:
during the object recognition, no other road user was recognized in the relevant region and, during the area recognition, the relevant region was recognized as a free drivable area; or
during the object recognition in the relevant region, another road user was recognized and, during the area recognition, the relevant region was not recognized as a free drivable area.

15. The assistance system according to claim 12, wherein the one or more processors of the assistance system are configured to:
classify the results of the object recognition and of the area recognition as inconsistent with one another;
make the driving decision to execute the safety measure; and
output the corresponding control signal when, during the object recognition, another road user was recognized in the relevant region and, during the area recognition, the relevant region was recognized as a free drivable area.

16. The assistance system according to claim 12, wherein the one or more processors of the assistance system are configured to:
classify the results of the object recognition and of the area recognition as inconsistent with one another;
make the driving decision to execute the safety measure; and
output the corresponding control signal when, during the object recognition, no other road user was recognized in the relevant region and, during the area recognition, the relevant region was not recognized as a free drivable area.

17. The assistance system according to claim 12, wherein:
the one or more processors of the assistance system are configured to carry out the object recognition based on surroundings data from an active surroundings scan using at least one of radar or lidar.

18. The assistance system according to claim 12, wherein:
the one or more processors of the assistance system are configured to carry out the area recognition based on a semantic segmentation of a camera image of the respective surroundings that is captured as part of the surroundings data.

19. The assistance system according to claim 12, wherein:
the one or more processors of the assistance system are configured to at least one of:
generate, in the case of results, inconsistent with one another, of the object recognition and of the area recognition, the control signal as a control signal to automatically stop the motor vehicle; or
request a confirmation to control, in particular to continue to move, the motor vehicle according to the planned driving maneuver from its driver.

20. A motor vehicle, which is configured for at least semiautomated operation and comprises:
a surroundings sensor system having at least one first surroundings sensor and one second surroundings sensor, which operate independently of one another and according to different functional principles;
an assistance system configured to provide at least semiautomated control of the motor vehicle, the assistance system comprising:
an input interface configured to capture surroundings data of at least two different surroundings sensors;
one or more processors configured to process the surroundings data and to generate a control signal depending on the surroundings data; and
an output interface configured to output the control signal;
wherein the one or more processors are configured to execute the steps of the method according to claim 11.
